(19) United States
(12) Patent Application Publication
(10) Pub. No.: US 2006/0034103 A1
(43) Pub. Date: Feb. 16, 2006

(54) Utility grid-interactive power converter with ripple current cancellation using skewed switching techniques

(75) Inventor: Rick West, Pismo Beach, CA (US)

Correspondence Address: DISTRIBUTED POWER, 3547-C SOUTH SOUTH HIGUERA ST., SAN LUIS OBISPO, CA, 93401, US

(73) Assignees: Rick West, San Luis Obispo, CA (US); Distributed Power, Inc., San Lusi Obispo, CA (US)

(21) Appl. No.: 10/710,957

(22) Filed: Aug. 14, 2004

(51) Int. Cl. H02M 1/12

(52) U.S. Cl. 363/39

(57) ABSTRACT

The invention is an electrical power conversion apparatus for converting DC voltage to poly-phase AC current where the AC current is supplied directly to the electric utility grid for power transfer into the grid. The power conversion apparatus has two or more separate, pulse modulated, high frequency power converters per phase. The outputs of the power converters are summed at a common connection point substantially on the load side of the main pulse filter inductors. The high frequency pulse train of each separate power converter is skewed or phase delayed with respect to the other converters on the same AC power phase for the purpose of reducing the amount of high frequency ripple current injected into the electric utility grid.

The following discussion illustrates the preferred embodiment of the invention. FIG. 1 shows four typical, three-phase bridge circuits, 1, 2, 3 and 4, connected to common DC source, 6. The high frequency switching elements of bridge circuits 1, 2, 3 and 4 are typically Insulated Gate Bipolar Transistors (IGBTs) with anti-parallel diodes. FIG. 1 illustrates these complex switch elements schematically, for the sake of clarity, as simple switches. Bridges 1, 2, 3 and 4 operate to convert DC power to low distortion three-phase sinewave currents synchronized with the three-phase utility grid voltages to provide substantially unity power factor power transfer into the electric utility grid 9. To achieve this, the DC source voltage must be higher than the peaks of the AC grid voltages. The power converter can be described as three, two-quadrant buck converters. Pulse filter inductors 5 are all of equal value and smooth the high frequency switching waveforms from the four bridges. Filter capacitors 8 provide a second, high frequency pole and operate in conjunction with said pulse filter inductors. The common points of filter capacitors 8 are the summing nodes for the individual inductor currents. Ideally the PWM filter inductors and filter capacitors would remove all of the switching frequency components and pass only pure 60 Hz sinewave currents into utility grid 9. The four-bridge topology illustrated in FIG. 1 is known, though atypical. If the switching elements of all of the bridges are operated in unison, there is no cost or performance advantage to using four bridges verses one bridge at four times the power. By using separate current regulator circuits for each bridge, and by skewing the Pulse Width Modulation (PWM) current regulator high frequency switching times by 90° for each successive bridge, substantial ripple current cancellation and ripple current frequency multiplication are achieved. In FIG. 1, four bridges are used where bridge 1 is skewed by 0° (reference point), bridge 2 by 90°, bridge 3 by 180° and bridge 4 by 270°. If three bridges were used, the individual bridges would be skewed by 120° each instead of 90°. If five bridges were used, the individual bridges would be skewed by 72° and so on.

FIG. 2 illustrates the benefits of this method in a four-bridge converter. The reference designators in FIG. 2 refer back to the power converter topology shown in FIG. 1. IA, IB and IC are the sinusoidal, 3-phase currents being sourced into the utility grid by the power converter shown in FIG. 1. The waveforms illustrated are three complete PWM switching cycles at 16 kHz or approximately 4° out of the total 360°, 60 Hz sinewave. The voltages shown are the voltages at the common point of each of the half-bridge switches. The currents I1A through I4C are shown without the low frequency 60 Hz current component for the sake of clarity. Each of the four currents, associated with a given phase, are combined at the utility interface. The four currents add algebraically to produce the composite waveform shown in IA DETAIL, IB DETAIL and IC DETAIL. These details now show the 60 Hz current component. Because the voltage waveforms associated with each phase are skewed by 90°, the composite, summed current waveform is four times the frequency of the constituent parts and with a reduction in amplitude. The four-bridge power converter has two null points where the ripple cancellation is theoretically complete, at the zero crossing of any given phase and when the duty cycle for any given phase is 75%. IB DETAIL in FIG. 2 is close to the zero crossing null point and IC DETAIL illustrates the 75% pulse width null point. At the point of least cancellation, in typical inverters with typical DC bus voltages, the ripple current amplitude is reduced by a factor of 8 verses an inverter running with four coincidentally switched bridges.

FIG. 3 illustrates a slightly different embodiment of the power converter shown in FIG. 1 where the electric utility is wye connected as opposed to the delta connection shown in FIG. 1.

FIG. 4 shows a simplified schematic of the AC line synchronized sinusoidal current regulator circuit. Current reference generator 1 produces a low distortion sinewave that is synchronized with the line-to-neutral utility grid voltage for a given phase. The amplitude of the current reference is adjusted by a microcontroller to set the amount of power being transferred into the utility grid in response to a number of conditions not pertinent to this discussion. Error amplifier 3 compares the feedback signal from current sensor 11 to the current reference and creates an error signal. This error signal is compared to a high frequency triangle wave and PWM comparator 4 creates pulses. These pulses are applied to top IGBT driver 5 and bottom IGBT driver 6. IGBTs 7 and 8 turn on or off, as a complimentary pair, in response to the drive signals. When IGBT 7 is “on”, current flows from the +DC connection through pulse filter inductor 12 and into electrical grid 13. When IGBT 9 is “on”, current flows from electrical grid 13 through pulse filter inductor 12 and into the −DC connection. Freewheeling diodes 8 and 9 conduct current and clamp the voltage at the common IGBT connection point during the IGBT switch transitions. The regulator works as a closed loop servo control system to force the current through pulse filter inductor 12 to be an exact scaled replica, at 60 Hz, of the current reference waveform. When the voltage on electrical grid 13 is positive (positive half sine), IGBT 7 is on more than IGBT 9 producing a net current flow into the grid. When the voltage on electrical grid 13 is negative (negative half sine), IGBT 9 is on more than IGBT 7 producing a net current flow out of the grid. In either case the power flow is into the grid. When the electrical grid voltage passes through zero, the “on” times of IGBT 7 and 9 are equal for a net zero current into or out of the grid.

To operate the four bridges shown in FIG. 1 with the intended time-skewed PWM pulse trains, twelve of these current regulators are required. The skewing is accomplished by delaying the triangle waveform used for regulating bridge 2 currents by 90°, bridge 3 by 180°, and bridge 3 by 270° with respect to bridge 1 at the switching frequency. To operate the four bridges shown in FIG. 1, three sinusoidal current references are required, one for each phase. More appropriate regulation methods for new products would be had using Digital Signal Processor(s) to perform the skewed PWM regulation under firmware control but based on the same algorithm described herein.

### BACKGROUND ART

This invention is intended for three-phase, electric utility-interactive DC to AC inverters for renewable and distributed energy applications.

Inverters for high power Distributed Energy (DE) systems currently use technology that is borrowed from the industrial motor drive, motive power and Uninterruptible Power Supply (UPS) industries. This adapted technology falls short of meeting critical requirements for commercially viable distributed energy systems. Specifically, state-of-technology DE inverters are expensive, heavy, and physically large.

Prior art DE inverters utilize power magnetic components that are physically large and heavy to allow the inverter to work with high conversion efficiencies. Basically, the larger the magnetic components, the lower the semiconductor switching frequency, the lower the semiconductor switching losses, the higher the conversion efficiency. The finished size, weight and cost of the inverter are largely driven by the magnetic filter components. The inverter conversion efficiency, however, is not a performance parameter that can be traded off for smaller magnetic components because the cost of the “green” energy, from a photovoltaic array, fuel cell or wind turbine is of such high value. For a given system output, any losses in the DE inverter must be made up in additional generating capacity in the DE source.

In all switch mode power converters, higher switching frequencies enable the use of smaller the magnetic components. The weight and size of magnetic components typically account for over 50% of the system weight and over 30% of the system size. These magnetic components are usually made from two materials, copper and iron. The semiconductor power switch module, another key power component, can become highly integrated and all of the system control can be put on one thumbnail sized microcontroller but the magnetics will still determine the equipment size and weight.

In DE inverters with power ratings greater than 10 kW, typically the switching and diode recovery losses of the IGBT power switches limit the maximum switching frequency, for a given conversion efficiency. These losses, at a given operating point, are the same for every switch cycle so that a machine running at 16 kHz will have twice the losses of the same machine running at 8 kHz. The trade-off is that for an equivalent amount of filtering, the 8 kHz operation would require twice the filter inductance.

The primary benefit of this invention is the accelerated maturation and commercialization of distributed energy systems. These systems include renewable generator sources such as photovoltaics, wind turbines and micro-hydro, quasi-renewable sources such as fuel cells, micro-turbine and advanced batteries as well as traditional generators such as gensets and lead-acid batteries. Specific applications include green power generation, grid support and peak shaving.

What is novel and claimed as the invention is a DC voltage to poly-phase AC current converter that sources current directly into the electric utility grid and operates with two or more phase shifted, high frequency bridges to reduce the high frequency current components injected into the utility grid. The power topology alone, without the control method, is not novel.

A method of skewing or phase delaying multiple power converters to achieve a reduction in switching frequency voltage ripple at a load is known and disclosed in U.S. Pat. No. 5,657,217 by Watanabe et al. The invention disclosed herein uses an analogous approach for reducing switching frequency ripple current at the electric utility grid point of connection. U.S. Pat. No. 5,657,217 is restricted to power converters that regulate a AC output voltages. The invention disclosed herein does not regulate AC output voltages and uses an entirely different regulation methodology.

### DESCRIPTION OF DRAWINGS

FIG. 1 illustrates the preferred embodiment of the invention where four, high frequency, three-phase, skewed bridge circuits are use to convert DC voltage to poly-phase AC current in a utility grid interactive inverter.

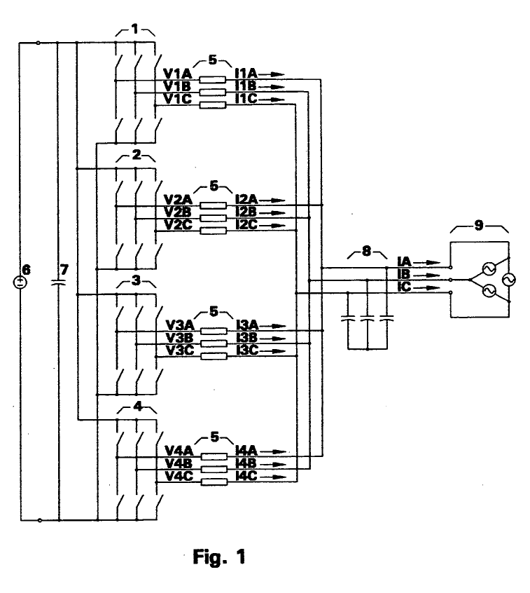

FIG. 2 illustrates the ripple current reduction and ripple current frequency multiplication had by skewing the PWM triangle waveforms of the individual power converters shown in FIG. 1.

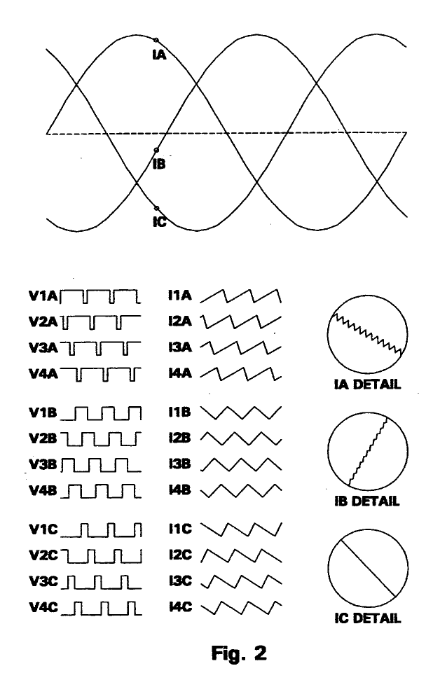

FIG. 3 illustrates a slightly different embodiment of the power converter shown in FIG. 1 where the electric utility connection is wye connected as opposed to the delta connection shown in FIG. 1.

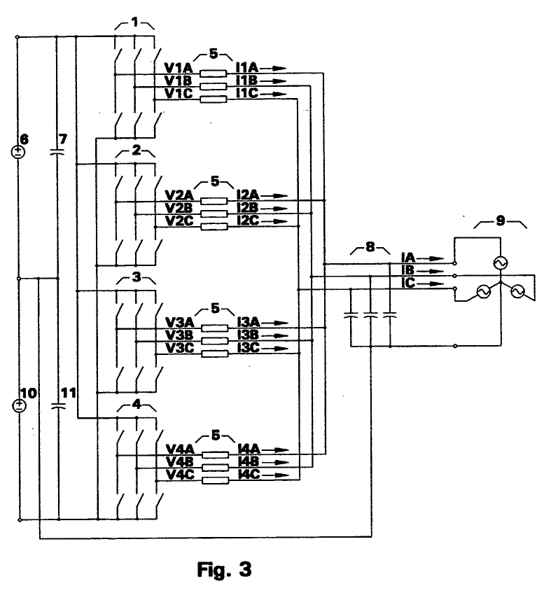

FIG. 4 is a simplified functional schematic of the regulator circuit used by each individual power converter.

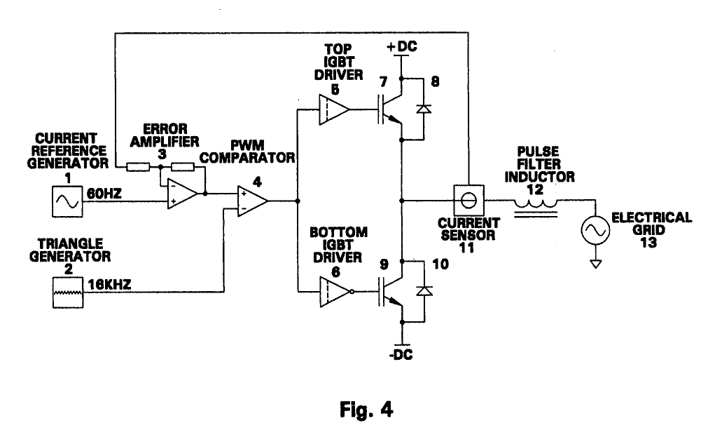

1. An electrical power conversion apparatus for converting DC voltage to poly-phase AC current where the AC current is supplied directly to the electric utility grid and comprising; (i) two or more separate, pulse modulated, high frequency power converters per phase where the outputs of said power converters are summed at a common connection point substantially on the load side of the main pulse filter inductors and where (ii) the high frequency pulse train of each separate power converter is skewed or phase delayed with respect to the other converters on the same AC power phase by an amount substantially equal to 360 degrees divided by the number of converters per phase for the purpose of reducing the high frequency ripple current at said common connection point and where (iii) said separate power converters have two semiconductor switch elements connected in series across a DC power source and where the center point of the two switches is connected to said pulse filter inductor in each power converter and further comprising, (iv) a method of sensing current through said pulse filter inductors and a method of generating a substantially sinusoidal current reference value and further comprising (v) a servo loop regulation circuit for each power converter that compares the current sensed in the pulse filter inductor to said current reference value and commands the semiconductor switch elements on and off to substantially regulate sinusoidal current into the electric utility grid substantially in phase with the electric utility grid voltage.
